(19) United States
(12) Patent Application Publication
(10) Pub. No.: US 2007/0164975 A1
(43) Pub. Date: Jul. 19, 2007

(54) Display device

(75) Inventors: Pang Guan Lim, Singapore (SG); Chun Hsing Wu, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,269

(22) PCT Filed: Feb. 28, 2005
(86) PCT No.: PCT/IB05/50722

§ 371 Date: Aug. 23, 2006

(30) Foreign Application Priority Data
Mar. 8, 2004 (EP) 04100937.4

(51) Int. Cl. G09G 3/36

(52) U.S. Cl. 345/102

(57) ABSTRACT

A display device (10; 200; 300; 400) including a display (20) for presenting images is described. The display (20) includes an illumination unit (25) for generating first radiation for illuminating a pixel liquid crystal display unit (20), the display unit (20) selectively transmitting the first radiation to generate second radiation for providing the images to the viewer (100). The illumination unit (25) also generates subsidiary radiation. The device further comprises filtering components ((40a, 40b; 210a, 210b; 310a, 310b, 410a, 410b) for filtering the subsidiary radiation to generate aura radiation (70) to supplement the images presented on the display (20). The display device (10; 200; 300; 400) is capable of providing the viewer (100) with reduced eye fatigue and an enhanced viewing experience.

### FIELD OF THE INVENTION

The present invention relates to display devices providing with subsidiary illumination; in particular, but not exclusively, the invention concerns a display device including a substantially flat-panel display providing ambient surround-lighting. Preferably, the flat-panel display is a back-lit liquid crystal display. Moreover, the present invention also concerns an ambient illumination apparatus which can be employed in combination with such flat-panel displays. Furthermore, the invention also relates to methods of creating ambient illumination when using flat-panel displays.

### BACKGROUND TO THE INVENTION

Laptop computers and similar types of portable display systems conventionally include an enclosure, a keyboard for data entry, one or more computing devices including associated memory components together with a back-lit liquid crystal display (LCD) comprising an array of display pixels. The one or more computing devices are arranged in operation to receive data entered at the keyboard as well as to process data to generate visual information to be presented to a user of the lap-top computer on its back-lit display.

It is found it practice that such laptop computers are occasionally used in conditions of reduced lighting, for example in bedrooms at night-time, in aircraft subject to subdued lighting during night-flights, in trains where ambient lighting is sometimes reduced for passenger comfort to mention a few examples. It has been appreciated that keys on keyboards of such lap-tope components are not easily visible in subdued lighting such that additional lighting to illuminate the keys has been proposed in a United Kingdom patent application GB 2,375,504 in the form of a keyboard illumination device releasably attachable to an upper edge of a laptop computer, and also in U.S. Pat. No. 5,684,513.

In U.S. Pat. No. 5,684,513, there is described an electronic luminescence keyboard system in a portable device including a plurality of keypads and an illuminated panel operable to display information in response to pressing at least one of the keypads. There is also included an optical conductor element for conducting a portion of the light from a portion of the illuminated panel via the conductor element for illuminating the plurality of keypads. Such illumination of the keypads allows observation of the keypads when a surrounding area is dimly lit. The system has substantially no effect on the power consumption of the portable device.

### SUMMARY OF THE INVENTION

An object of the present invention is to provide a display device including additional lighting for enhancing viewer experience when viewing the device. The inventions is defined by the independent claims. The dependent claims define advantageous embodiments.

According to a first aspect of the present invention, there is provided a display device including a display for presenting images to a viewer,
(a) the display including illuminating means for generating first radiation for illuminating pixel imaging means, said imaging means being operable to selectively transmit or reflect the first radiation to provide second radiation for generating the images for presentation to the viewer; and
(b) the illuminating means being additionally operable to generate subsidiary radiation, the device further comprising filtering means for filtering the subsidiary radiation to generate aura radiation to supplement the images presented on the display.

The invention is of advantage in that it is capable of reducing viewer eye fatigue and also providing an enhanced visual experience to the viewer. The inventors have appreciated that a laptop computer in use, for example for visiting numerous Internet sites or for watching DVD movies, can result in eye-fatigue as light output from a flat-screen display, for example LCD screen, fluctuates greatly from one image to another; such fatigue arises, amongst other things, as a consequence of rapid eye-pupil adjustment in response to rapidly fluctuating light output from the display. However, viewing such a display in conditions of relatively strong ambient lighting can cause contrast, color and/or color rendition of presented visual information to be disappointingly inadequate. Thus, the inventors have envisaged that it is desirable to include additional lighting to enhance viewing experience when using flat-panel displays such as LCD pixel displays, especially when general ambient illumination has been reduced. Similar considerations apply to flat-panel LCD televisions or monitors.

Preferably, the filtering means are adapted to generate the aura radiation for transmission to one or more of: peripheral regions to the display, and a surfaces of or within the display device for projecting the aura radiation.

Preferably, in the display device, the filtering means includes at least one of a prismatic or diffraction device for filtering the subsidiary radiation to generate the aura radiation. Such an approach provides a potentially continuously variable adjustment of aura color.

Preferably, in the display device, the filtering means includes, apart from or instead of a filter for filtering the amount of light, color filters for selecting a portion of the subsidiary radiation at preferred wavelengths for generating the aura radiation. Use of such color filters is of benefit in that it requires imprecise adjustment, especially with regard to radiation incidence angle, and is capable of being implemented at relatively low cost and complexity.

Preferably, in the display device, the filtering means is manually adjustable by the viewer. Alternatively, or additionally, the filtering means is beneficially adjusted by using actuating means coupled thereto. More preferably, for example when viewing program content from data carriers such as DVDs and/or from the Internet, or from off-air Television transmissions, adjustment of the actuating means is dependent on characteristics of program content presented on the imaging means.

Preferably, in the display device, the filtering means is adjusted by way of one or more of: tilting, lateral translation and scrolling motions for selecting a color of subsidiary radiation transmission therethrough.

Preferably, in the display device, the subsidiary radiation corresponds to normally wasted lateral radiation emitted from the illuminating means. Re-use of such normally wasted radiation means that the invention is capable of being implemented without significant increase in power dissipation.

Preferably, in the display device, the imaging means is implemented in at least one of: a liquid crystal display, an electronic ink display and a plasma-type display.

According to a second aspect of the present invention, there is provided a method of presenting images on a display of a display device to a viewer, the method including the steps of:
(a) generating first radiation from illuminating means for illuminating pixel imaging means;
(b) selectively transmitting the first radiation through said imaging means to generate second radiation for providing the images for presentation to the viewer; and
(b) generating subsidiary radiation at the illuminating means, using the subsidiary radiation to illuminate color filtering means for color filtering the subsidiary radiation to generate aura radiation for transmission to one or more of: peripheral regions to the display, and surfaces for generating aura radiation to supplement the images presented on the display.

It will be appreciated that features of the invention are susceptible to being combined in any combination without departing from the scope of the invention.

### DESCRIPTION OF THE DRAWINGS

These and other aspects of the invention are apparent from and will be elucidated with reference to the embodiments described hereinafter.

The invention will now be described, by way of example only, with reference to the following diagrams wherein:

FIG. 1 is a front view of an embodiment of the invention, namely a display device according to present invention;

FIG. 2 is a top view of the display device of FIG. 1 incorporating prismatic optical components;

FIG. 3 is a top view of the display device of FIG. 1 incorporating diffraction grating optical components;

FIG. 4 is a top view of the display device of FIG. 1 incorporating a roll plastics-material color-filter film;

FIG. 5 is a top view of the display device of FIG. 1 modified to include filter and/or diffraction optical components together with reflectors for illuminating a peripheral edge of a housing of the display device of FIG. 1; and

FIG. 6 is a top view of the display device and its surrounding.

### DESCRIPTION OF EMBODIMENTS OF THE INVENTION

The inventors have envisaged that it is feasible, for example in a case of a liquid crystal display (LCD) panel provided with back-lighting, to generate surround lighting, also referred as “aura”. Such surround lighting is preferably one or more of:
(a) backwardly projected light relative to a front face of the display normally presented to a viewer, the backwardly projected light being projected onto one or more surfaces behind the display; and
(b) laterally projected light for illuminating a peripheral region around the display, for example at least part of a surrounding edge region of an enclosure, for example translucent molded plastics material housing, employed to house the display.

Such surround lighting is especially pertinent to television monitors provided with LCD screens, especially those television monitors with relatively smaller displays where it is desirable to provide a more expansive screen appearance to viewers of the monitors. However, apart from such appearance aspects, the present invention is directed at addressing problems of eye fatigue and providing a pseudo-extension of a fine-detail display area without incurring the cost of using a fine detail large area LCD.

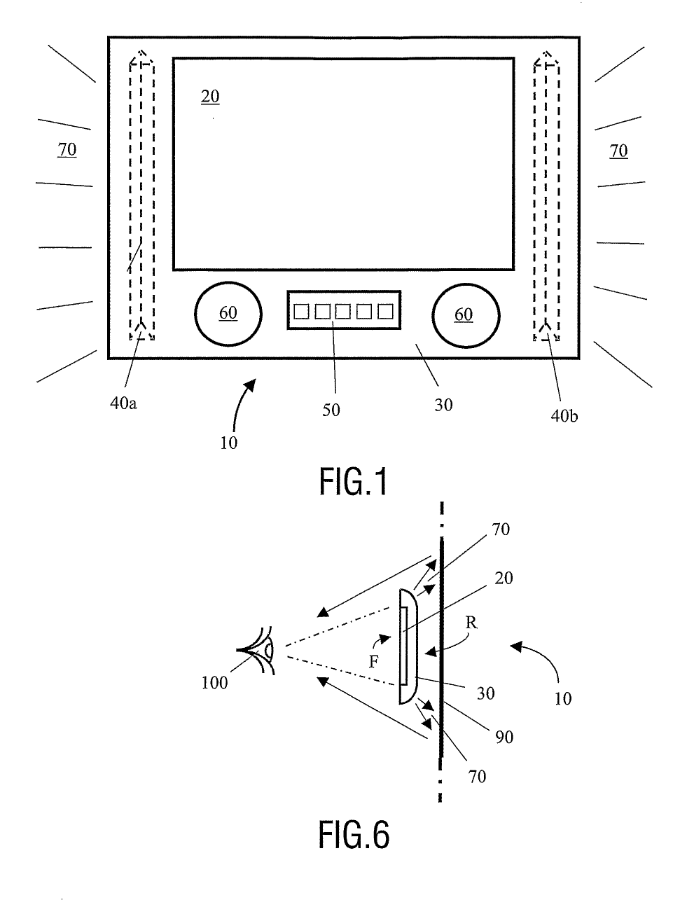

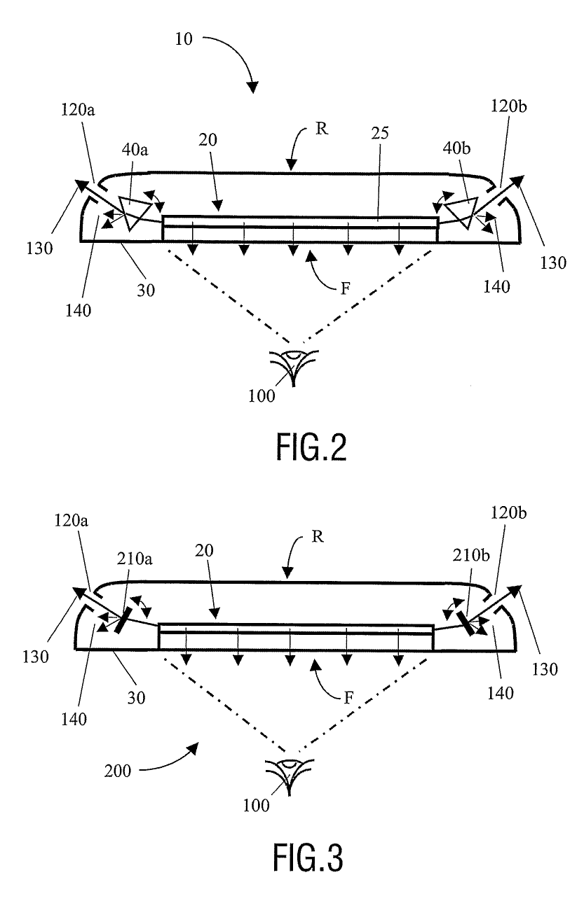

An embodiment of the invention is shown in FIG. 1. In FIG. 1, there is shown a television monitor, also known as a television receiver, indicated generally by 10. The monitor 10 includes a liquid crystal display (LCD) 20 for viewing at a front (F) part of a housing 30 at least partially enclosing the LCD 20. The LCD 20 is preferably a thin-film-transistor (TFT) matrix pixel display providing color image presentation. The LCD 20 also includes an illumination unit 25 as shown in FIG. 2 generating substantially white light so that the LCD 20 pixels are operable to selectively transmit red, green and blue components of the white light as appropriate to form an image on the LCD 20 for viewing by a viewer 100. The monitor 10 additionally includes a control panel 50, for example for changing channel, increasing sound volume, and so forth in addition to other known contemporary television control functions. Optionally, the monitor 10 is provided with a remote control. Moreover, the monitor 10 includes stereo speakers 60 for directing sound towards the viewer 100. At lateral side of the LCD 20, the monitor 10 additionally includes optical components 40a, 40b at left-hand-side and right-hand-sides of the LCD 20 respectively. The components 40a, 40b are operable to receive laterally radiated white light from the illumination unit 25 for extracting one or more color components or all components therefrom for radiating these extracted components laterally and backwards away from the viewer 100, as shown in FIG. 6, to illuminate a surface 90 provided behind a rear surface (R) of the monitor 10 and thereby give rise to a general illumination aura 70. This aura 70 is especially noticeable when the monitor 10 is placed closely in front of a white surface, for example by mounting the monitor 10 against a substantially white wall in a manner akin to hanging a painting on a wall. Preferably, one or more of the components 40a, 40b are adjustable with regard to a color which they transmit to form the aura 70 and preferably an angular direction in which to form the aura 70 is also modifiable. Preferably, adjustment of the components 40a, 40b is achieved electronically from the electronic controls 50 of the monitor 10, or from its remote control; in such an implementation, the components 40a, 40b are preferably actuated by miniature servo-motors.

An implementation of the monitor 10 is shown in FIG. 2 wherein the optical components 40a, 40b are implemented as elongate prisms disposed with their longitudinal axes of rotation substantially parallel to lateral edges of the LCD 20. The prisms are preferably fabricated from substantially-transparent molded plastics material, for example clear polycarbonate. The housing 30 includes lateral slots 120a, 120b adjacent to their associated optical components 40a, 40b respectively. Radiation emitted from the illumination unit 25 of the LCD 20 propagates through the components 40a, 40b, namely prisms, and desired wavelength radiation propagates as rays 130 out of the housing 30 and onto surfaces extending laterally behind the monitor 10. If required, radiation emitted from the illumination unit 25 can be conveyed by light guides, for example molded plastics material light guides to at least one of the components 40a, 40b. Moreover, radiation emitted from the illumination unit 25 of the LCD 20 at wavelengths, namely colors, not desired by the viewer 100, namely radiation 140 is deflected to a blackened interior surface of the housing 30 whereat this radiation 140 is absorbed. If desired, one or mote slits or apertures can be optionally included between the LCD 20 and housing 30 in a vicinity of the slots 120a, 120b or before the components 40a, 40b for providing more precise color discrimination.

The components 40a, 40b are also susceptible to being implemented in alternative ways. For example, a monitor indicated by 200 in FIG. 3 is similar to the monitor 10 in FIGS. 1, 2, except that the components 40a, 40b are implemented by elongate diffraction gratings 210a, 210b operating in either transmissive or reflecting modes. The gratings 210a, 210b are preferably implemented as relatively inexpensive plastics materials parts with a diffraction grating pattern pressure embossed thereon. Pivoting the diffraction gratings 210a, 210b about their elongate axes parallel to lateral edges of the LCD 20 enables the viewer 100 to select a preferred color for forming the aforementioned aura 70. If required, one or more apertures and/or lenses can be included in conjunction with the gratings 210a, 210b for enhancing their optical performance.

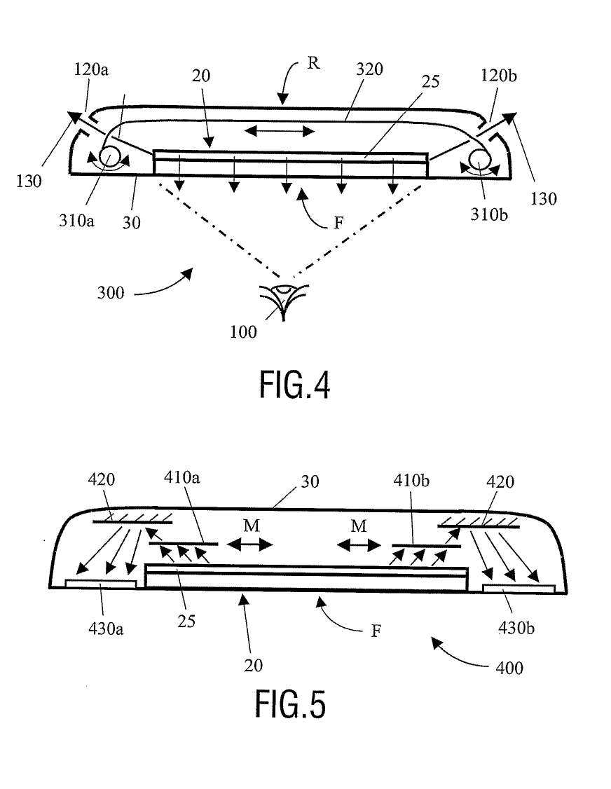

In a further embodiment of the invention, the monitor 200 can be modified by replacing the gratings 210a, 210b by one or more color filters that can be mechanically moved to achieve preferred color selection. Such filters are preferably implemented on thin substantially-transparent plastics material film coated with color filtering material. Preferably, the plastics material film can be rolled into two rolls at both ends thereof, in a manner akin to a conventional photographic film in a camera spooling from one roll to another, and actuated by rotating the rolls. Other implementations are also possible, for example two motor-actuated rolls at lateral sides of the LCD 20 with the color plastics-material filter film, for example having regions thereof providing different color filter characteristics, passing behind the LCD 20 in a gap between the LCD 20 and a rear inside surface of the housing 30 in a manner as illustrated in FIG. 4 and indicated generally by 300 wherein a plastics-material color filtering film is denoted by 320 and its two end rolls denoted by 310a, 310b. One or more of the rolls 310a, 310b are preferably motor actuated; for example, one of the rolls 310a, 310b can have a spiral return spring coupled thereto whereas the other roll is driven by a motor or a knob preferably on a top or side region of the housing 30 to enable the viewer 100 to select a preferred color for the aura 70.

Where generation of the aura 70 on the rear surface 90 adjacent to the monitor 10, 200, 300 is not practicable, the housing 30 can be adapted to include or receive deployable rear white panels as surface for presenting the aura 70 to the viewer 100. Optionally, the panels can be pivotally mounted to a rear portion of the housing 30. Optionally, these or other panels may be adjustable to direct the aura radiation to a user adjustable location. Alternatively the adjustment of the direction may be realized by moveable optical components. Alternatively, or additionally, the monitor 10, 200, 300 can be arranged to include translucent panels 430a, 430b in an embodiment of the monitor indicated by 400 in FIG. 5. The monitor 400 includes the LCD 20 together with color filtering optical components 410a, 410b, for example implemented as diffraction gratings or color filters. Moreover, the monitor 400 also includes reflecting mirrors 420 for receiving back-directed radiation from the illumination unit 25 of the LCD 20 filtered via the optical components 410a, 410b to select one or more color components therefrom and then reflecting the filtered back-directed radiation onto the translucent panels 430a, 430b so that the viewer perceives the aura 70 as being within the housing 30. Optionally, one or more translucent panels in the housing 30 can be included together with an option of projecting the aura 70 onto a rear surface as described earlier, for example by including one or more partial apertures in the mirrors 420 for transmitting a portion of the filtered back-directed radiation through further slots in the housing 30 in a manner of the slots 120a, 120b. The components 410a, 410b are preferably arranged to be actuated laterally (M), for example by a servo-motor and/or manually by the viewer 100, or pivoted to affect color selection.

It will be appreciated that formation of the aura 70 in a region above a top edge or below a bottom edge (for example, when the housing 30 is wall-mounted) of the LCD 20 is also feasible to enhance a visual effect achieved. If required, presentation of a preferred color is made depending upon program content presented on the LCD 20. Selection of the color can be automatic, if desired, in response to the program content being displayed, for example by way of computer control from within the monitor 10, 200, 300, 400.

If required, the aura 70 can be optionally supplemented by radiation from other types of sources, for example light emitting diodes (LEDs), such LEDs being appropriately accommodated within the housing 30. However, the monitors 10, 200, 300, 400 as shown are of benefit in that they utilize lateral radiation arising from the illumination unit 25 which is required to illuminate the LCD 20 and therefore potentially does not add further power dissipation to the monitors 10, 200, 300, 400 and contributes relatively insubstantially to its cost of manufacture.

It will be appreciated that the LCD 20 is susceptible to being implemented in alternative technology with backlighting, for example utilizing light-transmissive electronic ink which is back-lit, or with a display having the illumination unit 25 not at a rear side but at left, right, top or bottom side. Moreover, the LCD 20 may also be a reflective LCD, which modulates the amount of reflection of light originating from the illumination unit 25. Moreover, although the monitor 10, 200, 300, 400 has been described primarily in the context of televisions, it is equally applicable to desktop and portable computers, computer game devices, medical displays and so forth.

The aura 70 is capable of ensuring that the viewer's 100 eyes do not have to vary their aperture, namely their pupils, over a wide range in response to changing subject matter presented on the LCD 20 resulting in variations of light transmission from the illumination unit 25 to the viewer 100. In consequence, the viewer's 100 eyes are obliged to adjust less when viewing the LCD 20 when the aura 70 is employed and therefore the monitors 10, 200, 300, 400 are capable of providing less viewer strain. Moreover, an enhanced viewing experience is achieved by the visual effect.

It will be appreciated that embodiments of the invention described in the foregoing are susceptible to being modified without departing from the scope of the invention as defined by the accompanying claims.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display device (10; 200; 300; 400) including:
a display (20) for presenting images, the display (20) including illuminating means (25) for generating first radiation for illuminating pixel imaging means, said imaging means being operable to selectively transmit or reflect the first radiation to provide second radiation for generating the images, the illuminating means (25) being additionally operable to generate subsidiary radiation; and
filtering means (40a, 40b; 210a, 210b; 310a, 310b; 410a, 410b) for filtering the subsidiary radiation to generate aura radiation (70) to supplement the images presented on the display (20).

2. A device (10; 200; 300: 400) according to claim 1, the filtering means being adapted to generate the aura radiation (70) for transmission to one or more of: a peripheral region to the display (20), and a surface (90) of or within the display device for projecting the aura radiation (70).

3. A device (10, 200) according to claim 1, the filtering means including at least one of a prismatic (40a, 40b) or diffraction (21Oa, 210b) device for filtering the subsidiary radiation to generate the aura radiation (70).

4. A device (300; 400) according to claim 1, the filtering means including color filters (310, 310b, 320; 410a, 410b) for selecting a portion of the subsidiary radiation at preferred wavelengths for generating the aura radiation (70).

5. A device according to claim 1, the filtering means being manually adjustable by the viewer (100).

6. A device according to claim 1, the filtering means being adjustable by actuating means coupled thereto.

7. A device according to claim 6, an adjustment of the actuating means being dependent on characteristics of program content presented on the imaging means.

8. A device according to claim 1, the filtering means being adjustable by way of one or more of: tilting, lateral translation and scrolling motions for selecting a color of subsidiary radiation transmission therethrough.

9. A device according to claim 1, the subsidiary radiation corresponding to normally wasted lateral radiation emitted from the illuminating means.

10. A device according to claim 1, the imaging means being implemented in at least one of a liquid crystal display, and an electronic ink display.

11. A device according to claim 1, the filtering means being adapted for controlling a direction of the aura radiation (70).

12. A method of presenting images on a display (20) of a display device (10; 200; 300; 400), the method including the steps of:
generating first radiation from illuminating means (25) for illuminating pixel imaging means (20);
selectively transmitting or reflecting the first radiation to generate second radiation for providing the images for presentation to the viewer (100); and
generating subsidiary radiation at the illuminating means (25), and filtering the subsidiary radiation to generate aura radiation to supplement the images presented on the display.
